(19) United States
(12) Patent Application Publication
(10) Pub. No.: US 2019/0070603 A1
(43) Pub. Date: Mar. 7, 2019

(54) SYSTEM FOR CHARGING AND DISCHARGING AIR UNDER A CONTROLLED PRESSURE

(71) Applicant: UNIVERSIDAD DE SEVILLA, Sevilla (ES)

(72) Inventors: Francisco Antonio PERDIGONES SANCHEZ, Sevilla (ES); Jose Manuel QUERO REBOUL, Sevilla (ES)

(21) Appl. No.: 16/085,317

(22) PCT Filed: Mar. 14, 2017
(86) PCT No.: PCT/ES2017/000027

§ 371 Date: Sep. 14, 2018

(30) Foreign Application Priority Data
Mar. 15, 2016 (ES) P201600223

(51) Int. Cl. B01L 3/00

(52) U.S. Cl. CPC B01L 3/502707; B01L 3/502738; B01L 2300/049; B01L 2300/0816; B01L 2400/0487; B01L 3/502715

(57) ABSTRACT

The present invention is directed to a system for charging and discharging air under a controlled pressure. This is a mechanical and electronic connection system that produces an accumulation of energy in chambers of fluid devices, and the subsequent opening thereof to convey liquid samples. It belongs to the field of industrial engineering. The main uses of this invention are: manufacturing fluid devices for controlling samples in a reliable manner, making the devices easier to use since pressurisation and electrical connection are simultaneously obtained, in biological and chemical processes involving a controlled movement of samples and, more specifically, the inclusion thereof in lab-on-a-chip or μTAS platforms, providing a quantum jump in the quality and versatility of automatic laboratory protocols in devices having approximately the size of a credit card.

### FIELD OF THE INVENTION

The object of the present invention is a mechanical and electronic connection system, which produces energy accumulation in fluidic device chambers, and its subsequent opening to drive liquid samples.

The field of the invention corresponds to industrial engineering, in particular manufacturing or microfabrication, electronics and fluidics. Sectors in which the invention would be applied are: the pharmaceutical industry, to manufacture devices for the analysis and production of drugs; the environmental sector, to manufacture devices for measuring parameters such as water PH or any other fluid, included fluids in gaseous state; the chemical sector, to manufacture devices for reactions and analysis of substances in the devices in which the invention is incorporated; the food industry for parameters measuring devices such as lactose, glucose or gluten; the sanitary sector for the manufacturing of devices, portable or not, of blood, urine, or saliva analysis among others.

### DESCRIPTION OF THE RELATED ART

Currently, the control of small volumes of fluids, in the order of microliters or nanoliters, is one of the aspects that are most booming because their potential has not been fully developed. Furthermore, due to the improvement that these advances imply when they are combined with biological or chemical applications, systems are developed in parallel that improve more and more the measurements systems of traditional laboratories. Especially, this improvement consists in the minimization of the liquid volumes to be used, reducing the cost of the analysis and, at the same time, reducing the diagnostic times, being able to reach diagnosis in real time. In addition, very varied laboratory procedures, such as mixing, washing, chemical reactions, sensing, etc. can be integrated in the same device. For that reason, the laboratory equipment is reduced to a small laboratory that fits in a card of the order of centimetres. This also implies a finer control of the measurement since the location of the equipment in the analysis card will always be the same and, being electronically controlled at the same time. Its small size makes possible to move the device-laboratory from one place to another.

Besides all these characteristics, it is also sought to be very low-cost so that its competitiveness in the market is remarkable.

When testing samples in this type of devices, the most common solution is connect the device directly to external pressure sources or syringe pumps with constant flow, such as those developed in US2008/0248590A1, US7601269B2, US 2012/0067433A1, U.S. Pat. No. 8,323,488 B2, U.S. Pat. No. 8,747,604 B2, U.S. Pat. No. 6,810,713 B2, U.S. Pat.No. 7,744,762 B2, US20040028566 A1, which need fluidic connections between the external actuators and the device. To make this device more manageable, portable and reliable, it is necessary to eliminate this type of fluidic connections and externa actuators. In this sense, and increasing the level of development, there are systems that do not require external fluidic connections to produce the movement of liquids, nor transfer the sample to another device to measure it, as it Is explained in US 2012/0021527 A1. That case is a system in which a single fluid-sample evolves in a single non-reconfigurable channel, but not in U.S. Pat. No. 8,685,325 B2, which can be reconfigured by electrowetting. However, this latter device has the disadvantages that it requires a complex network of electrodes, as well as any complicated interface, through the control electronics. In that sense, the system described in US 20080019866 A1 acts by capillarity without external forces, not needing interfaces, but this way makes it not externally controllable.

There are more developed solutions, such as the one of US 20050232817 A, US 2005/0130292 A1, US20050130226 A1, US8367397 B2 in which the system uses a solid propellant to achieve the liquid impulses, by controlled external action, and a manual impeller for distribution of a liquid pattern. This makes the manufacturing process more complex due to the placement of the solid propellant with micrometric precision. In addition, because of the actuation at low temperature, they could be activated without control due to the sun-air temperatures in many countries, so their use is limited. This last solution claims pressure chambers in a lab on chip device, so that the invention presented in this document is a good complement for it. This is because the pressurized chambers must be loaded in some way, in that case during the manufacturing process, which causes pressure losses over time, due to the polymeric materials used. In this document, a chamber charging system is proposed, at the moment of its use, minimizing pressure losses. In addition, it is parallelizable and efficient for controlled movement of fluids. The characteristics of the proposed system are expanded in the following paragraph.

In the invention proposed in this document, a connection system for controlled accumulation of energy in the form of pressure for devices is presented. Its main feature is the elimination of fluidic connections and minimization of pressure losses, which characterizes as reliable and portable.

Energy is accumulated at the time of use, eliminating pressure losses cause by aging in slightly permeable and pre-charged chambers during its manufacturing process. This accumulated energy is released by acting through the slot for electrical connection, opening the valves associated with the chambers, in order to produce the controlled movement of the liquid samples that are going to be analysed. The opening of the chambers does not necessarily depend on the temperature or ambient pressure, which makes the system more robust. The dimensions of the chambers determine, together with the pressure, the displacement of the samples.

### CITATIONS LIST

1.—US2008/0248590A1, Device For Carrying Out A Biological Assay, November 2004; Owner: Norchip As; Researchers: Anja Gulliksen, Lars Anders Solli, Frank Karlsen

2.—U.S. Pat. No. 7,601,269B2, On-chip sample preparation for whole blood analysis, October 2009; Owner: Ahn Chong H, Aniruddha Puntambekar, Alok Jain, Jungyoup Han; Researchers: Ahn Chong H, Aniruddha Puntambekar, Alok Jain, Jungyoup Han

3.—US 2012/0067433A1, Device and method for controlling fluid flows in lab-on-a-chip systems and method for producing said device March 2012; Concesionario original: Katja Friedrich, Walter Gumbrecht, Peter Paulicka; Researchers: Katja Friedrich, Walter Gumbrecht, Peter Paulicka

4.—U.S. Pat.No. 8,323,488B2, IC-processed polymer nano-liquid chromatoraphy system on-a-chip and method of making it, Decekber 2012; Owner: California Institute Of Technology, City Of Hope; Researchers: Yu-Chong Tai, Qing He, Jun Xie, Changlin Pang, Terry D. LEE, Damien Rodger, Matthieu Liger.

5.—U.S. Pat No. 8,747,604 B2, Method for manufacturing a microfluidic chip, and related chip and plate, June 2014; Owner: Centre National De La Recherche Scientifique (Cnrs), Universite Paris-Sud 11; Researchers: Anne-Marie Gosnet-Haghiri, Clement Nanteuil

6—U.S. Pat. No. 6,810,713 B2, Method for handling and delivering fluid on a lab-on-a-chip, November 2004; Owner: Lg. Electronics Inc.; Researchers: Jong Hoon Hahn, Kwanscop Lim, Kihoon Na, Suhyeon Kim, Je-Kyun Park

7.—U.S. Pat. No. 7,744,762 B2, Microfluidic devices and methods facilitating high-throughput, on-chip detection and separation techniques, June 2010; Owner: Virginia Tech Intellectual Properties, Inc.; Researchers: luliana M. Lazar

8.—US20040028566 A1, Microfluidic device for the controlled movement of fluid, February 2004; Owner: Ko Jong Soo, Yoon Hyun Chul, Yang Hae Sik, Dae-Sik Lee, Chung Kwang Hyo, Pyo Hyeon Bong, Kim Sung Jin, Kim Yun Tae; Researchers: Jong Ko, Hyun Yoon, Hae Yang, Dae-Sik Lee, Kwang Chung, Hyeon Pyo, Sung Kim, Yun Kim.

9.—US 2012/0021527 A1, Lab-on-a-chip for alkalinity analysis, January 2012; Concesionario original: Hach Company; Researchers: Corey Alan SALZER, Vishnu Vardhanan Rajasekharan, Isabel Nicola Huenig, Rainer Froemel, Markus Lenhard, Rolf Dieter Uthemann, Aria Farjam.

10.—U.S. Pat. No. 8,685,325 B2, Field-programmable lab-on-a-chip based on microelectrode array architecture, April 2014; Owner: Sparkle Power Inc.; Researchers: Gary Chorng-Jyh Wang, Ching Yen Ho, Wen Jang Hwang, Wilson Wen-Fu Wang

11.—US 20080019866 A1, Lab-On-A-Chip For An On-The-Spot Analysis And Signal Detection Methods For The Same, jan 2008; Owner: Se-Hwan Paek, Joo-Eun Kim; Researchers: Se-Hwan Paek, Joo-Eun Kim

12.—US 20050232817 A1, Functional on-chip pressure generator using solid chemical propellant, October 2005; Owner: The University Of Cincinnati; Researchers: Chong Ahn, Chein-Chong Hong, Suresh Murugesan, Sanghyo Kim, Gregory Beaucage

13.—US 2005/0130292 A1, Smart disposable plastic lab-on-a-chip for point-of-care testing, June 2005, Owner: The University Of Cincinnati; Researchers: Chong Ahn, Jin-Woo Choi, Gregory Beaucage, Joseph Nevin

14.—US20050130226 A1, Fully integrated protein lab-on-a-chip with smart microfluidics for spot array generation, June 2005, Owner: The University Of Cincinnati; Researchers: Chong Ahn, Junhai Kai, Young-Soo Sohn

15.—U.S. Pat. No. 8,367,397 B2, Active biochip for nucleic acid analysis, February 2013, Concesionario original: Honeywell International Inc.; Researchers: Yuandong Gu, Leon Xu

16.—U.S. Pat. No. 7,601,269 B2, On-chip sample preparation for whole blood analysis, October 2009, Owner: Ahn Chong H, Aniruddha Puntambekar, Alok Jain, Jungyoup Han; Researchers: Ahn Chong H, Aniruddha Puntambekar, Alok Jain, Jungyoup Han.

### SUMMARY OF THE INVENTION

The present invention is defined as a mechanical and electronic connection system, which produces energy accumulation in fluidic device chambers, and its subsequent opening to drive liquid samples. The sector to which its development belongs is industrial engineering. The technical problem that resolves is the pressurization at the time of use, of chambers, so as not to have losses of pressure from the manufacturing when it reaches the user for its use. So that, when these chambers are activated, reliable control is obtained in the situation of the liquids inside the device. In addition, the problem that is also solved is the achievement of the pressurization of the chambers and the electrical connection of the device simultaneously. All with a simple manufacturing. The main uses of this invention are the following:

The incorporation of the invention in the manufacture of fluidic sample control devices makes said control reliable. In addition, it facilitates the use at the user level since the pressurization and electrical connection is simultaneous. It is for all of this that biological or chemical processes that involve controlled movement of samples, can be carried out automatically and portable using a system such as the one proposed by the invention. In particular, its main use would be its inclusion in lab on chip platforms or μTAS, which would provide a leap in quality in the versatility of automatic laboratory protocols in devices of the size of a credit card approximately.

### BRIEF DESCRIPTION OF THE DRAWINGS

FIG. 1: Parts of mechanical and electrical connection system.

FIG. 2: Plan view of the connection system.

FIG. 3: Lab on a chip (4) inserted in the connection port (1).

FIG. 4: Mechanical and electrical connection system parts for an example of parallel chamber pressurization.

FIG. 5: Plan view of the connection system shown in FIG. 4.

FIG. 6: Mechanical and electrical connection system parts for an example of parallel pressurization of chamber systems.

FIG. 7: Plan view of the connection system for the case of FIG. 6.

FIG. 8: Cross section in which an inert fluid that separates sample and wall has been included

FIG. 9: Plan view of the system in which an inert fluid that separates sample and wall has been included.

FIG. 10: Sample injected into the mechanical port to be encapsulated. Placement of the plug in the mechanical port for the encapsulation of the sample previously injected in said port

FIG. 11: Cross section of the system connected to the connection port, in which the encapsulated sample is

FIG. 12: Plan view of the system connected to the connection port, where the encapsulated sample is

FIG. 13: System without connecting to the connection port, in which encapsulated samples are combined with two chambers to be pressurized.

FIG. 14: System connected to the connection port, in which encapsulated samples are combined with two chambers to be pressurized.

FIG. 15: Manufacturing process from lab to chip.

FIG. 16: Manufacturing process of the connection port

FIG. 17: Fabrication of the purge port

FIG. 18: Plunger on the upper face of the device, not inserted.

FIG. 19: Plunger introduced by the upper face of the device for pressurizing chambers.

FIG. 20: Plunger on the underside of the device, not inserted.

FIG. 21: Plunger introduced by the lower face of the device for pressurizing chambers.

### DETAILED DESCRIPTION OF THE INVENTION

The fabrication of devices for the impulsion of fluid samples is generally based on the use of external machines, such as syringe pumps or external pressure sources. This dependence makes them non portable, that is, they cannot be carried from one place to another with ease. The solutions proposed so far are based on the pressurization of chambers during the manufacturing process. This fact makes its applicability very limited because the pressure is lost over time, due to the porosity of the materials. The solution proposed with this invention is the pressurization of the device at the time of its use, together with an electronic connection to control the different sensors and actuators that could be part of the device. For that purpose, this invention is defined as a mechanical and electronic connection system that produces energy accumulation in chambers and their subsequent opening. One part of the system consists of a connection port including a plunger and a slot for electrical connection. The other part of the system is a device formed by channels and chambers which, once it is connected to the connection port, a plunger is inserted into the mechanical port, storing energy as air pressure inside the chambers, in a controlled way. These chambers have valves which can be activated as desired. In this way, pressurized air is released in a channel within the device, in which there are liquid samples which are pushed by that air, causing its movement. The system also supports the encapsulation of samples, and a multiple operation.

Apart of the advantages previously explained related to the pressurized devices during the process, the method of fabrication is simple and inexpensive with respect to those using solid propellant or integrated micropumps, which require a complex manufacturing process, occupy a considerable space in the device and need a complicated control system. Furthermore, the control of the liquids location is not necessary in the proposed solution, since it is implied by the design of the dimensions of the invention.

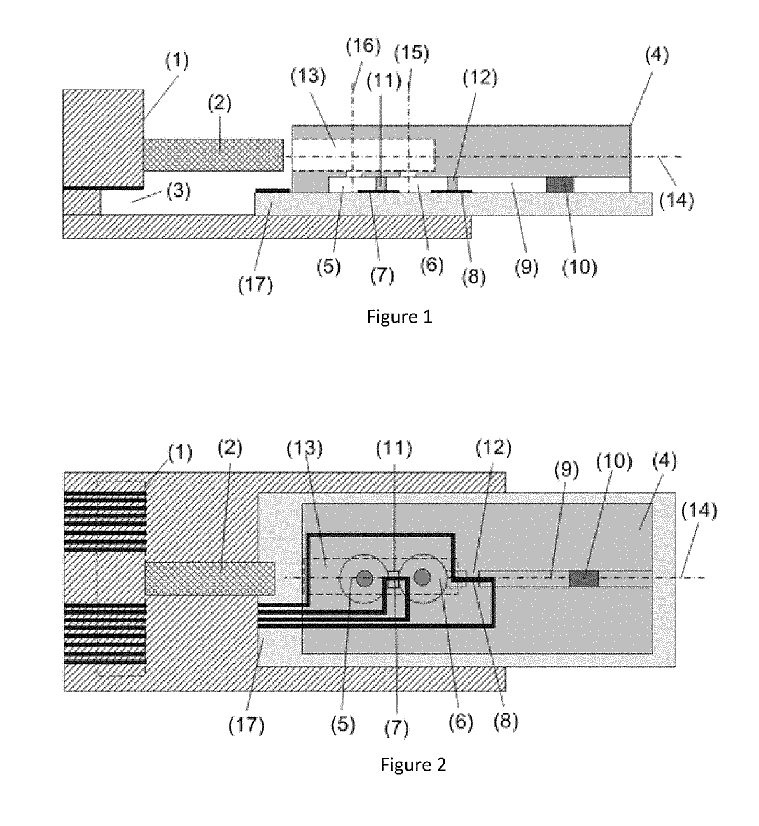

The present invention relates to a connection system for controlled accumulation of energy in the form of pressure in chambers. It will be described for the case of two chambers, (5) and (6). The parts of the connection system are shown in FIG. 1. This system is formed with a plunger (2), which is inserted in a mechanical port (13), to which the chambers (5) and (6), in which to accumulate the energy, are connected. That chambers (5) and (6) are initially at atmospheric pressure, and belong, in this particular case, to a device (4) which is a lab-to-chip microfluidic platform (LOC). FIG. 1 represents a section of the structure according to the plane containing the axes (14) and (15), and FIG. 2 is a top view.

The plunger (2) is a plastic cylinder with a circular section. The mechanical port (13) of the lab on chip (4) is a circular section pipe that fits without loss of pressure to the plunger (2). The pipe communicates with the chambers (5) and (6) which are in the lab on chip (4).

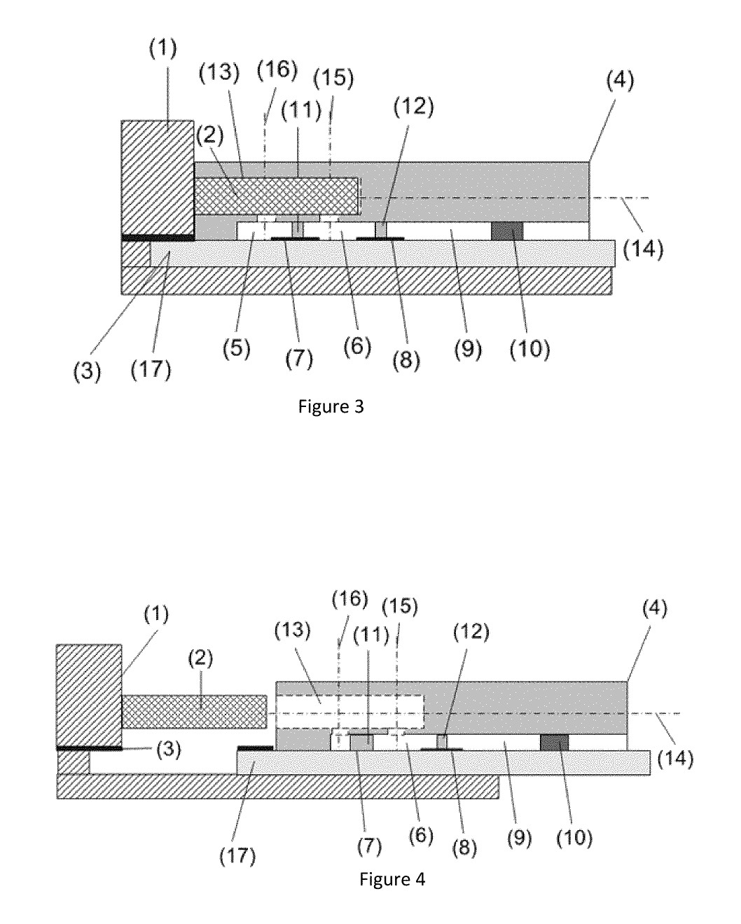

To make the connection, the lab on chip (4) is introduced into the connection port (1), so that the plunger (2) is inserted in the cylindrical cavity corresponding to the mechanical port (13) and, at the same time, the electrical projection (17) from the lab to chip (4) is inserted in the slot for the electrical connection (3). In this way, the chambers (5) and (6) are charged with energy in the form of pressure, and each chamber at a desired pressure, where the previous chamber (5) will have a lower pressure than the back pressure (6). The energy charge is sequential and controlled, with the chamber (5) being charged first, and then the chamber (6). FIG. 3 shows the lab on a chip (4) inserted in the connection port (1).

After the insertion of the lab on chip (4) into the connection port, (1) there is an electrical connection to activate the valves (7) and (8). FIG. 1 shows the configuration of the valve (7), in which the wall (11) is arranged perpendicular to such valve and superimposed to it. The valve (7) is activated by an electric current from the slot of the electrical connection (3) through the electronic board (17) destroying its superimposed wall (11). The valve (8) has the same configuration and it is activated in the same way as the valve (7). The material of the valves is copper, with dimensions such that they act as a fuse with a sufficiently large electric current. When the fuse is destroyed due to a high current, it breaks the wall that is superimposed.

Once the chambers are charged, and with the electrical connection set, the flow of the fluid sample (10) inside the channel (9) is carried out in the following way:

Firstly, the valve (8) is opened through the port (3) breaking its superimposed wall (12), so that the stored energy in the form of pressure air is transferred to the fluid sample (10) in the form of kinetic energy, and therefore causes its movement. Next, the valve (7) is opened to perform the second impulsion, in which its superimposed wall (11) is broken, so that the energy stored in the chamber (5) pushes the sample (10) along the channel (9). The lengths that run through the samples inside the lab on chip are closely related to the pressures to which the chambers have been charged.

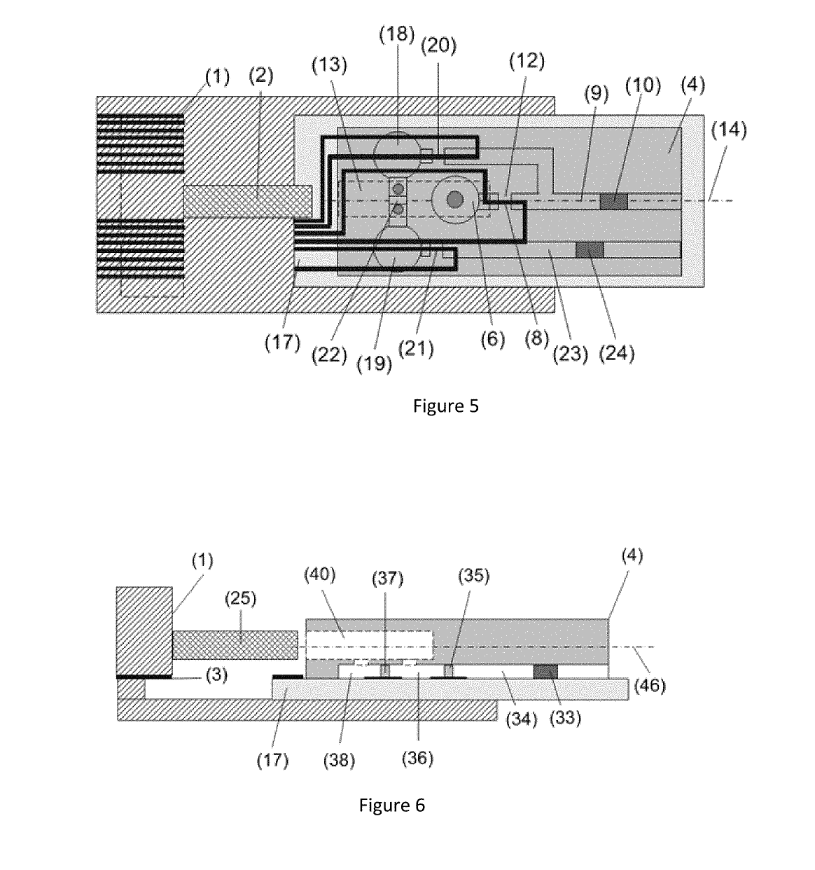

The pressure load is parallelizable, since several chambers can be charged at the same time just having them connected together. This system can be seen in FIGS. 4 and 5. FIG. 4 is a cross section on the same plane as FIG. 1, and FIG. 5 is its top view.

In FIGS. 4 and 5 the same scheme of FIGS. 1 and 2 is maintained, with the difference that the chamber (5) has been replaced by two chambers (18) and (19) separated from each other by the wall (22), so that they are connected individually to the mechanical port (13). In the same way as in FIG. 1, in FIG. 4 the chamber (18) is associated to the wall (20) under which its corresponding valve is located. In parallel, the chamber (19) is associated to the wall (21) under which its corresponding valve is located. The chamber (18) is connected through the wall (20) to the channel (9).

However, the chambers do not have to share a channel, as is the case with the chamber (19) that communicates with the channel (23) through the wall (21). With this particular configuration, which serves as an example for the parallel pressurization of chambers, the following sequence can be achieved. Once the three chambers (6), (18) and (19) are loaded due to the insertion of the plunger (2) in the mechanical port (13), the valves are activated independently. Firstly, the valve associated to (19) is activated in such a way that the movement of the liquid sample (24) occurs along the channel (23), according to the same principle explained in FIGS. 1 and 2. Secondly, the valve associated to the chamber (5) is activated causing the movement of the sample (1) along the channel (9). Finally, the valve associated to the chamber (18) is activated in such a way that the liquid sample (10) located in the channel (9) is pushed back. This trigger sequence is used as an example, and any other sequence is also valid, as many as permutations allow the number of chambers used, and it is even possible to activate simultaneously. All the activations are made from the connection port (1), through the electrical connection (3) and the board (17) until reaching the desired valve, as already mentioned above.

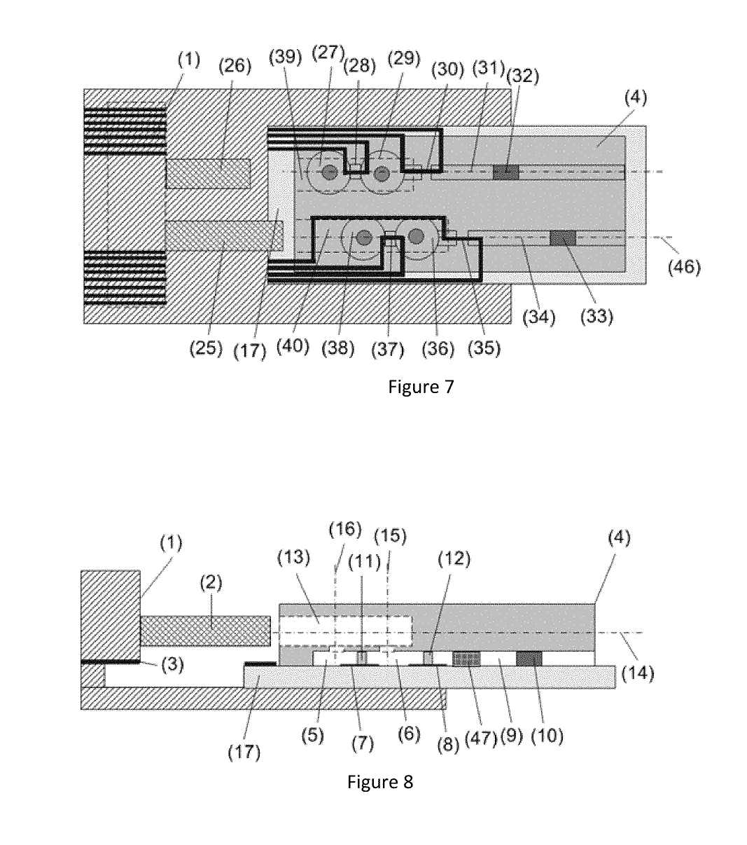

The pressure load is also parallelizable for a series of chambers, that is, several series of chambers can be loaded at the same time. For this, it is enough to have several pistons in the connection port that are introduced in the lab on chip (4). The insertion of these pistons may be simultaneous or not, and the length of the pistons and their cross-sectional area do not have to be the same. This system, as an example, is presented in FIGS. 6 and 7. FIG. 6 being a cross section on the plane containing the axis (46) and is perpendicular to the lab on chip (4), and FIG. 7 is its top view.

As an example of parallelization of series of chambers to be pressurized, FIGS. 6 and 7 are presented. In this example, the parallelization of two series of chambers is done, one in the upper part, corresponding to the chambers (27) and (29), and the lower one, represented by chambers (36) and (38). In this case, it is needed as many pistons as series of chambers, and therefore, there will be two pistons, (25) and (26), the first one for the lower system and the other one for the upper system. These pistons do not have to be of the same length, shape, section or material. The system is connected as mentioned above. In this case the plunger (25) will be inserted into the mechanical port (39) and the plunger (26) will be inserted in the (40). In this way, all the chambers are charged up to a desired pressure. The subsequent operation, from the activation of the valves associated with each chamber onwards, is the same as the one mentioned for FIG. 1 for each independent system. These activations can be simultaneous or not. In addition, it is possible to pressurize as many systems as necessary. The systems are not necessarily identical. Finally, any combination between parallelization of chambers and systems is admissible.

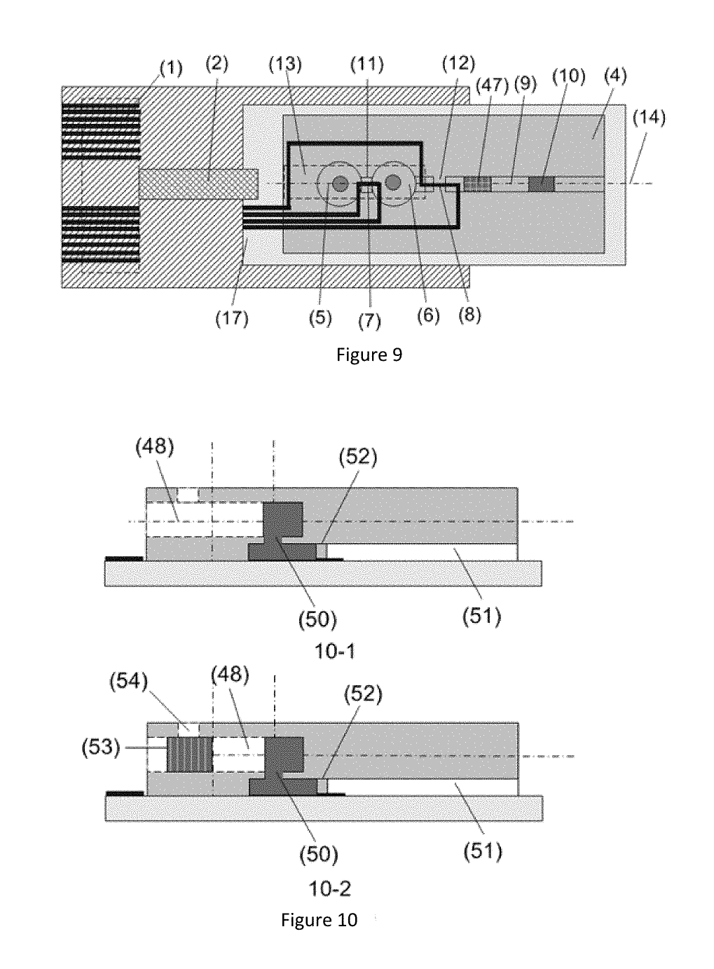

The system admits the inclusion of an inert fluid (47) in the lab on chip, depending on the application, as silicone oil or sterile saline solutions among others, located after the wall and outside the chamber. In this way, the fluid that is under pressure does not have direct contact with the samples to be propelled. The diagram of this situation is shown in FIG. 8 and its plan view in FIG. 9. That figure represents the same system of FIG. 1 but with the inert fluid (47), in this case a liquid, included to perform that function. The placement of this inert fluid (47) can be done in any of the pressurization configurations discussed above. The use of different fluids according to the chamber that precedes them is possible.

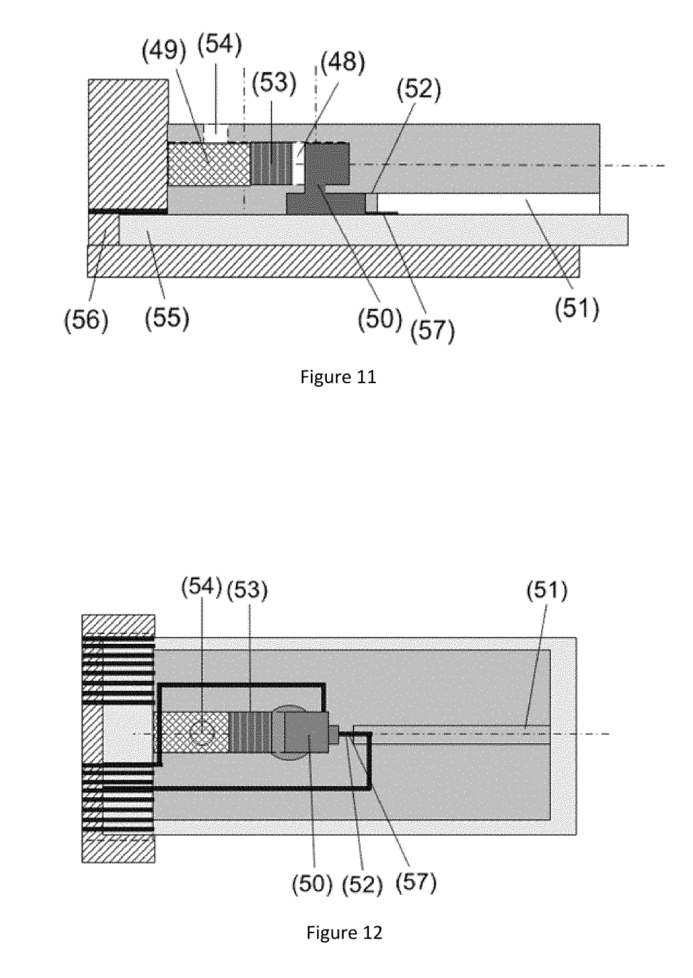

The system also supports the placement of the samples in the chambers to be pressurized, so that they would be encapsulated in the lab on a chip. This particular case is shown in FIG. 10, FIG. 11 and its plan view (FIG. 12), where the configuration would be as follows:

The mechanical port (48) where the plunger (49) enters has been previously filled with a certain volume of a sample (50) that is intended to be driven into the channel (51) and through the wall (52), FIG. 10.1. After this filling, which, if it would be necessary, can be performed in an environment of inert gas such as nitrogen, the introduction of a plug (53) that closes the mechanical port (48) is carried out. That plug (53) is inserted until it reaches the purge port (54), and also closes it, FIG. 10.2. Once these two steps have been carried out, the lab on chip device is used as in the previous cases, that is, it is introduced into the connection port, so that the plunger (49) would be introduced in the mechanical port (48) and the electrical protrusion (55) in the corresponding slot (56), FIGS. 11 and 12. In this way, the plunger (49) pushes the plug (53) by pressurizing the gas from the mechanical port (48). The activation would be the same as in the previous cases, through the destruction of the wall (52) that is on the valve (57). Since the number of mechanical ports can be more than one, the encapsulated samples can be more than one, with only the necessary mechanical ports available in the device (4). The volume of inert fluid, as well as the non-encapsulated samples, are placed in the device in the same way as explained in this paragraph, that is, they are previously encapsulated and then driven to place them in the desired place of the device.

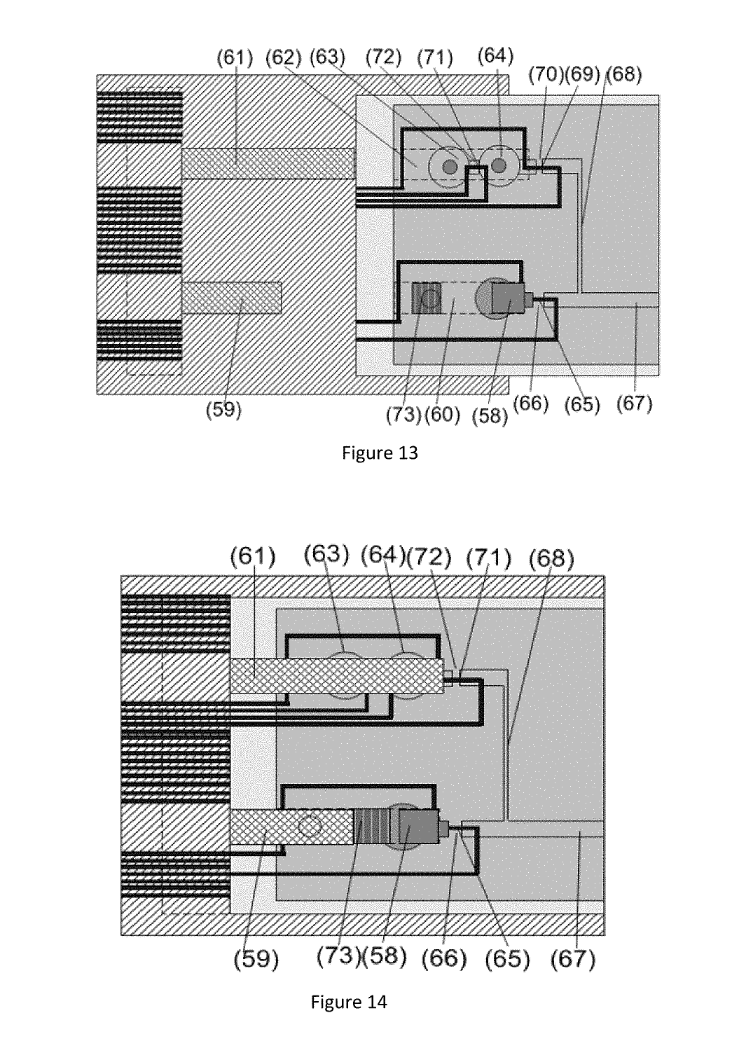

The liquid encapsulation system discussed above is compatible with the other configurations described. In this way, both configurations can be incorporated into the same device. As an example, one of the possible configurations is presented, see FIGS. 13 and 14, where the plan view is presented for its explanation. In FIG. 13 the system is shown before pressurization and in FIG. 14 after it.

The system supports, among others, the following activation sequence. Once the sample (58) is encapsulated in the lab on chip after placing the plug (73), it is connected to the connection port so that the plunger (59) is inserted in the mechanical port (60) pushing the plug (73) and pressurizing the chamber in which the sample is located (58). On the other hand, the plunger (61) is introduced at the same time in the mechanical port (62) so that the chambers (63) and (64) are charged with energy in the form of pressure. The valves are activated to drive the liquids. First, the valve (65) which is located under the wall (66) is activated by driving the encapsulated liquid towards the channel (67), so that it flows not penetrating the channel (68) due to the difference in section. Once the sample (58) driven is stopped, the valve (69) is activated, destroying the wall (70) so that the pressure of that chamber is released and the sample is again driven (58). Finally, the valve (71) is activated, destroying the wall (72), so that the sample (58) is again propelled along the channel (67).

### DETAILED DESCRIPTION OF THE EMBODIMENTS

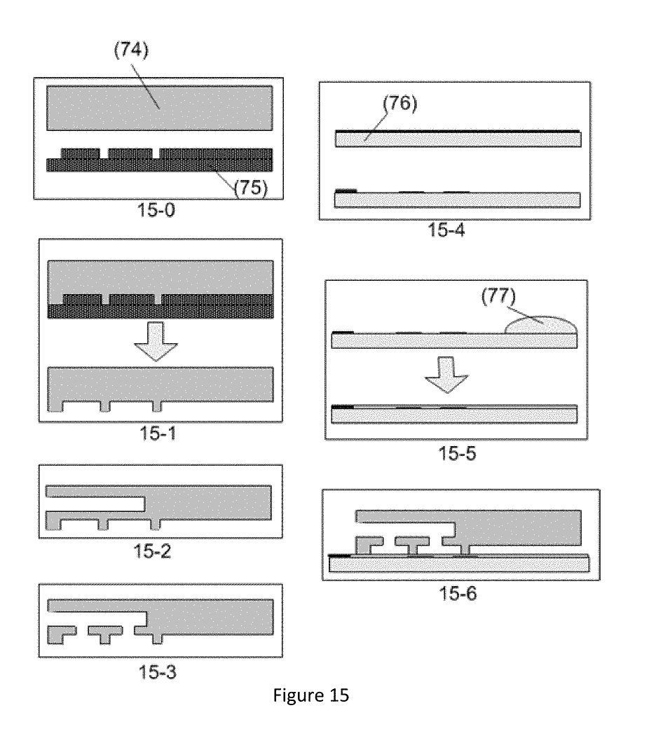

FIG. 15 shows the manufacturing process based on FIGS. 1 and 2.

It starts from a PMMA substrate (74) and an aluminum mold (75) to manufacture the channel (9), walls (11) and (12), as well as the chambers (5) and (6), FIG. 15- 0 For that purpose, through the hot stamping technique and using the aluminum mold (75), the chambers (5) and (6), the walls (7) and (8) are made on the underside of the substrate. In addition, at the same time and through the same technique, a channel (9), through which the fluid sample will flow once it acaquires the kinectic energy, is made, see FIG. 15-1. To manufacture the mechanical port (13), a hole is made on the side face of (68) according to the axis (14) of FIG. 1, see FIG. 15-2. Next, the cylindrical cavity formed with the chambers (5) and (6) is communicated, for this a through hole is made according to the axis (15) of FIG. 1, and from below to communicate with the mechanical port (13), and another through hole according to the axis (16) of FIG. 1, and from below to communicate with the mechanical port (13), see FIG. 15-3.

Electronic copper tracks are made by photolithography and chemical attack on a “Printed Circuit Board” (PCB) (76), see FIG. 15-4.

To glue both parts, a quantity of glue (77) is deposited on the top face of the PCB so that a thin layer is left, see FIG. 15-5. Finally, the upper face of the PCB (76) is pasted with the copper tracks, to the lower face of the manufactured PMMA structure, so that the chambers (5) and (6) of its lower part are closed for their part lower. Subsequently, pressure is applied to obtain an adequate contact and the glue is cured, see FIG. 15-6.

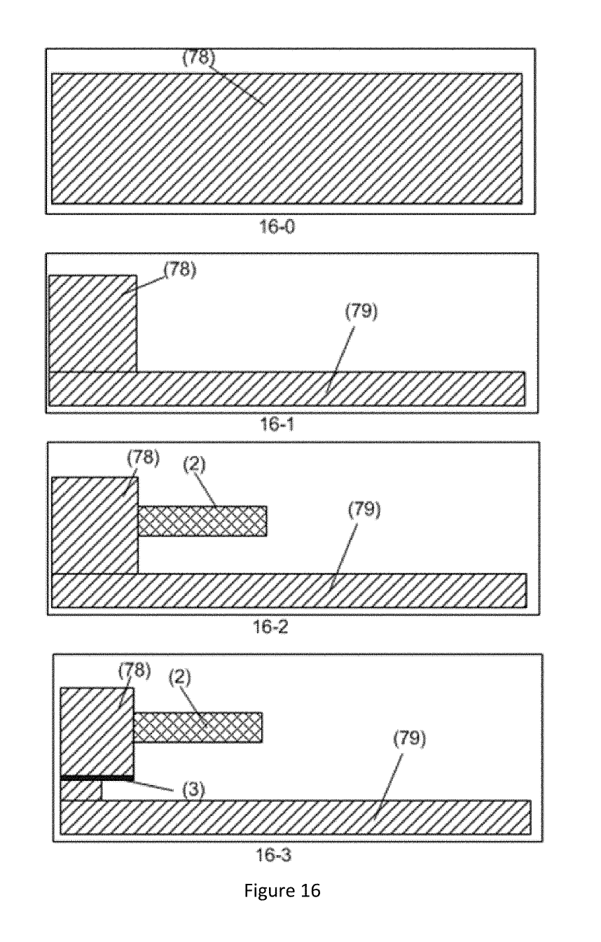

The manufacture of connection port 1 is part of a plastic volume (78), FIG. 16-0, which is milled to delimit the base-guide of the connection port (79), see FIG. 16-1. Then, a plastic cylinder is made to form the plunger (2), see FIG. 16-2. Furthermore, a groove is made in that sheet by milling, in order to place the electrical connection (3), see FIG. 16-3. Connections to the electronic device responsible for activating valves arrive at this slot.

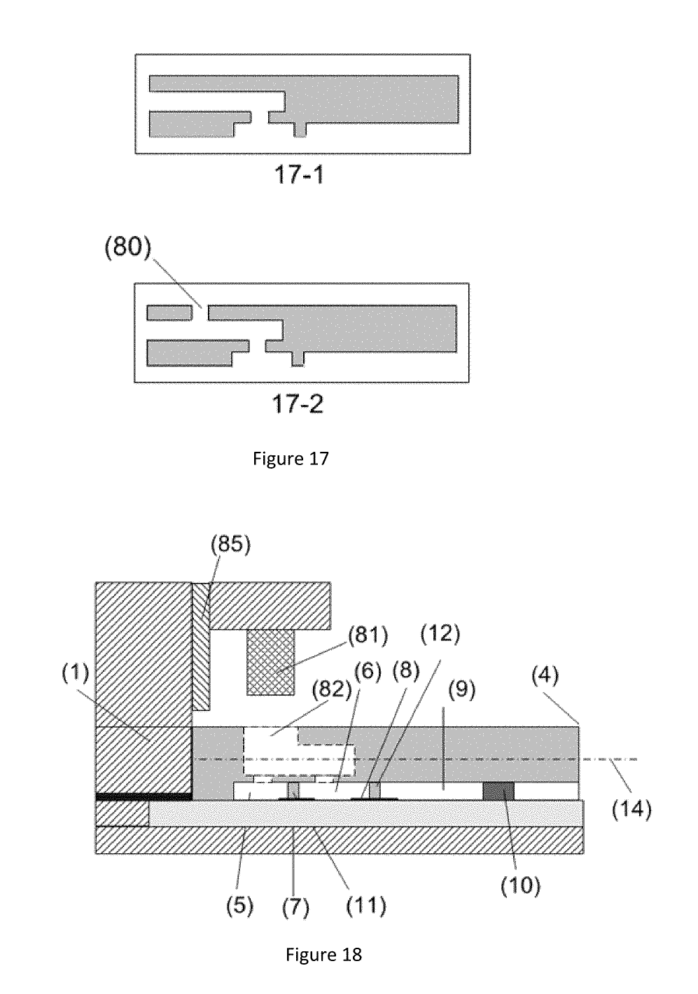

Additionally, for the manufacture of the sample encapsulation ports, only one additional hole is required, FIG. 17. That hole corresponds to the purge port of the encapsulation system (80). FIG. 17-1 corresponds to the system manufacturing discussed in this section but with a single chamber, while FIG. 17-2 shows the through hole (80) that defines the purge port for the case of encapsulation of samples. The rest of chambers and channels are made in the same way as described above.

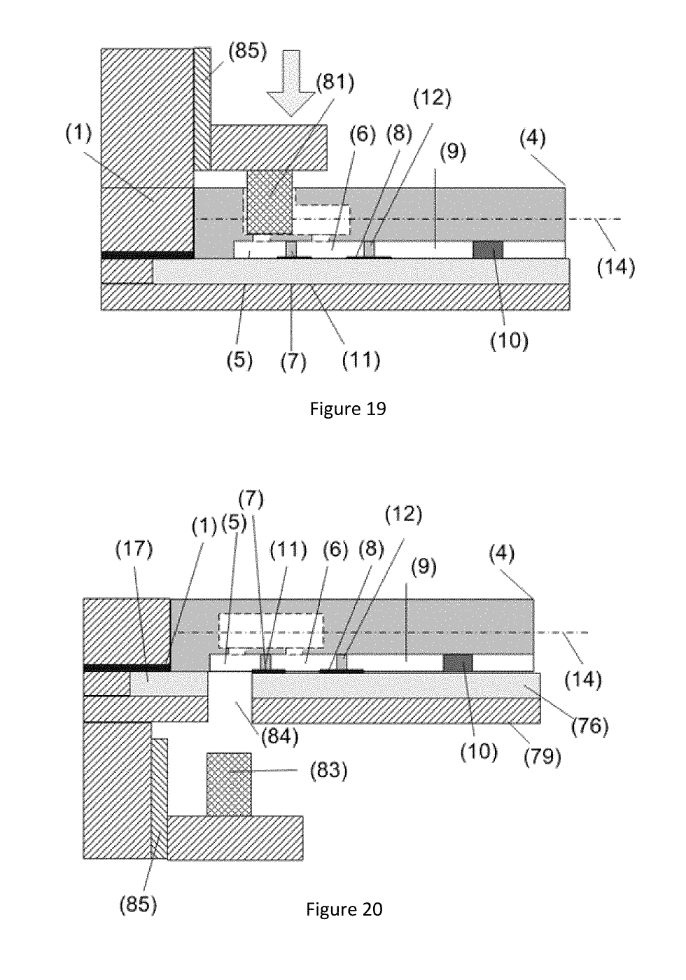

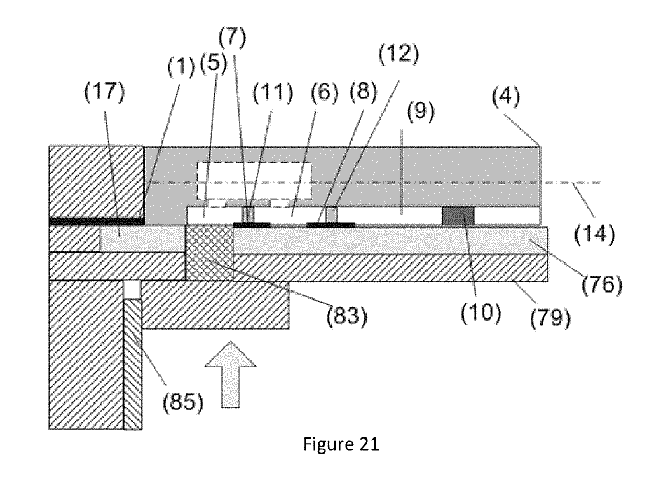

There is the possibility of pressurizing the chambers through the upper and / or lower part of the device, instead of, or in conjunction with, the lateral pressurization that has been described up to now. The case of pressurization by the upper part of the device is shown in FIG. 18 and FIG. 19. FIG. 18 represents the system before being pressurized, where the plunger (81) does not penetrate the mechanical port (82). While in FIG. 19 the system is shown after making the pressurization, where the plunger (81) has been introduced in the mechanical port (82) because it can be moved vertically by the sliding surface (85). The pressurization at the bottom is analogous to the upper one, FIGS. 20 and 21, where the plunger (83) is inserted into the mechanical port (84) through the guide base (79) and the PCB substrate (76). In the same way as above, a sliding surface is used to produce the vertical movement needed.

1. Air charging system in controlled pressure chambers characterized in that the loading takes place by inserting a plunger or more into a mechanical port, where the pistons may or may not have the same length and shape and be manufactured or not with the same material.

2. Air charge system in controlled pressure chambers according to claim 1, characterized in that the chambers are made of polymer material that are generated by hot embossing and gluing on printed circuit board (PCB) substrate.

3. Air charging system in controlled pressure chambers according to the previous claims, characterized in that the pressure is released by breaking polymer walls, for which a copper track belonging to the substrate printed circuit boards (PCB) is destroyed and located under said wall.

4. Air charging system in controlled pressure chambers according to claim 3, characterized in that the copper track acts as a valve.

5. Air charging system in controlled pressure chambers according to previous claims characterized in that it has one more electrical connectors for the actuation of the valves.

6. Air charging system in controlled pressure chambers according to the preceding claims, characterized in that the connector comprises both the signals of the actuator of the valves and signals of any other electrical or electronic component.

7. Air charging system in controlled pressure chambers according to previous claims, characterized in that the same piston presses more than one chamber at the same time.

8. Air charging system in controlled pressure chambers according to the previous claims, characterized in that several pistons load independent chamber systems simultaneously.

9. Air charging system in controlled pressure chambers according to the preceding claims, characterized in that the insertion of at least one of the pistons is by the upper and/or lower surface of the device whose chambers are to be loaded.

10. Air charging system in controlled pressure chambers according to previous claims, characterized by the presence of at least one inert fluid in the outlet of some chamber, to avoid contamination of samples.

11. Air charging system in controlled pressure chambers according to the previous claims, characterized in that the manufacturing material is glass, silicon, metals and / or plastics in all or at least one of its parts.

12. Air charging system in controlled pressure chambers according to the previous claims, characterized in that the manufacturing material can be machined by milling, drilling, chemical etching, reactive ion etching (RIE), deep reactive ion etching (DRIE), etching wet (“wet etching”) or plastic injection.

13. Pressurization system in which, according to previous claims, the union of the manufacturing materials is made by chemical, thermal or mechanical phenomena.

14. Air charging system in controlled pressure chambers according to the previous claims, characterized in that the pressurized gas is different from air.

15. Air charging system in controlled pressure chambers according to previous claims, characterized in that encapsulated liquids are included within the one or more mechanical ports encapsulated with a plug.
